(19) United States
(12) Patent Application Publication
(10) Pub. No.: US 2024/0236985 A1
(43) Pub. Date: Jul. 11, 2024

(54) METHOD AND APPARATUS FOR PUCCH TRANSMISSION

(71) Applicant: LENOVO (BEIJING) LIMITED, Beijing (CN)

(72) Inventors: Haipeng LEI, Beijing (CN); Yu ZHANG, Beijing (CN)

(21) Appl. No.: 18/557,461

(22) PCT Filed: Apr. 30, 2021
(86) PCT No.: PCT/CN2021/091450

§ 371 Date: Oct. 26, 2023

(51) Int. Cl. H04W 72/1273; H04L 1/1812; H04W 72/0446; H04W 72/231

(52) U.S. Cl. CPC H04W 72/1273; H04L 1/1812; H04W 72/0446; H04W 72/231

(57) ABSTRACT

Embodiments of the present disclosure relate to PUCCH transmission. According to some embodiments of the disclosure, a method may include: receiving a DCI format for scheduling a plurality of PDSCHs on a serving cell of the UE; and transmitting a first number of PUCCHs carrying HARQ-ACK feedback for the plurality of PDSCHs, wherein the plurality of PDSCHs is divided into the first number of PDSCH sets, and HARQ-ACK feedback for each of the first number of PDSCH sets is carried by a corresponding PUCCH of the first number of PUCCHs.

### TECHNICAL FIELD

Embodiments of the present disclosure generally relate to wireless communication technology, and more particularly to physical uplink control channel (PUCCH) transmission.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). In the case that a DCI schedules a PDSCH, the UE may transmit hybrid automatic repeat request acknowledgement (HARQ-ACK) feedback (e.g., HARQ-ACK feedback information bit(s)) for the PDSCH through a PUSCH or a physical uplink control channel (PUCCH).

There is a need for handling PUCCH or HARQ-ACK feedback transmissions in a wireless communication system.

### SUMMARY

Some embodiments of the present disclosure provide a method for wireless communication performed by a user equipment (UE). The method may include: receiving a downlink control information (DCI) format for scheduling a plurality of physical downlink shared channels (PDSCHs) on a serving cell of the UE; and transmitting a first number of physical uplink control channels (PUCCHs) carrying hybrid automatic repeat request acknowledgement (HARQ-ACK) feedback for the plurality of PDSCHs, wherein the plurality of PDSCHs is divided into the first number of PDSCH sets, and HARQ-ACK feedback for each of the first number of PDSCH sets is carried by a corresponding PUCCH of the first number of PUCCHs.

Some embodiments of the present disclosure provide a method for wireless communication performed by a base station (BS). The method may include: transmitting a downlink control information (DCI) format for scheduling a plurality of physical downlink shared channels (PDSCHs) on a cell of the BS; and receiving a first number of physical uplink control channels (PUCCHs) carrying hybrid automatic repeat request acknowledgement (HARQ-ACK) feedback for the plurality of PDSCHs, wherein the plurality of PDSCHs is divided into the first number of PDSCH sets, and HARQ-ACK feedback for each of the first number of PDSCH sets is carried by a corresponding PUCCH of the first number of PUCCHs.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Some embodiments of the present disclosure provide an apparatus. The apparatus may include a processor and a transceiver coupled to the processor. The processor and the transceiver may be configured to interact with each other to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings.

These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a HARQ-ACK feedback transmission for DL transmissions scheduled by a DCI format in accordance with some embodiments of the present disclosure;

FIG. 3 illustrates a schematic diagram of HARQ-ACK feedback transmissions for DL transmissions scheduled by a DCI format in accordance with some embodiments of the present disclosure;

FIG. 4 illustrates a flow chart of an exemplary procedure of wireless communications in accordance with some embodiments of the present disclosure;

FIG. 5 illustrates a flow chart of an exemplary procedure of wireless communications in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

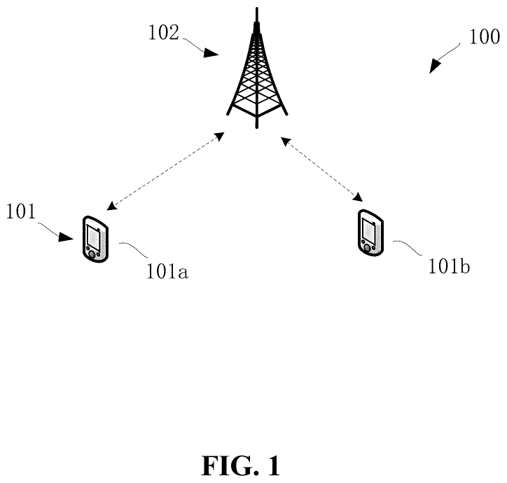

FIG. 1 illustrates a schematic diagram of a wireless communication system 100 in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

NR Release 17 is designed to expand the frequency range to 71 GHz. Due to the phase noise effect at a high frequency band, higher subcarrier spacing (SCS) may be specified for the purpose of reliability. For example, 240 kHz SCS, 480 kHz SCS, 960 kHz SCS, and even 1920 kHz SCS may be considered. It is known that the higher the SCS, the shorter the duration of a slot. For example, Table 1 below shows exemplary slot durations for different SCS. It should be understood that Table 1 is only for illustrative purposes, and should not be construed as limiting the embodiments of the present disclosure.

TABLE 1
Slot durations for different SCS

| μ | Δf = 2^{μ} · 15 [kHz] | Slot duration | |
|---|---|---|---|
| 0 | 15 | 1 | ms |
| 1 | 30 | 0.5 | ms |
| 2 | 60 | 0.25 | ms |
| 3 | 120 | 0.125 | ms |
| 4 | 240 | 0.0625 | ms |
| 5 | 480 | 31.25 | μs |
| 6 | 960 | 15.625 | μs |

In the above Table 1, the SCS configuration p is associated with the SCS (listed in the second column of Table 1). For example, “μ=3” may indicate a SCS of 120 kHz, and the slot duration for such SCS is 0.125 ms.

As shown in above Table 1, the duration of a single slot for, for example, 480 kHz SCS or 960 kHz SCS is quite short. When a UE is configured to monitor a PDCCH per slot, the power consumption of the UE will become a major problem. However, if a UE is configured to monitor a PDCCH every several slots, according to the current scheduling framework, for example, one PDCCH in one slot can schedule only one PDSCH or one PUSCH within one slot, therefore such scheduling framework will lead to resource waste due to some slots being unscheduled.

In view of the above, it would be beneficial to allow a single DCI format to schedule multiple slots when a relatively high SCS is applied. For example, in some embodiments of the present disclosure, a single DCI format may schedule a plurality of PDSCHs (hereinafter, “multi-PDSCH scheduling”) or PUSCHs (hereinafter, “multi-PUSCH scheduling”). Such scheduling schemes are beneficial because they can, for example, save DCI overhead. In certain application scenarios, for example, an NR-U system (NR system access on unlicensed spectrum systems), such scheduling schemes can avoid the risk of losing the channel on a unlicensed spectrum.

In some embodiments of the present disclosure, when a DCI schedules multiple PDSCHs, HARQ-ACK feedback timing for the multiple PDSCHs may satisfy certain requirements including, for example, the following:
For a UE and for a serving cell, scheduling multiple PDSCHs by a single DL DCI and scheduling multiple PUSCHs by a single UL DCI are supported.
   Each PDSCH or PUSCH has an individual/separate TB(s) and each PDSCH/PUSCH is confined within a slot.
   At least for 120 kHz SCS, single-slot scheduling with slot-based monitoring will still be supported as specified in Release 15 and Release 16.
The following will not be considered.
   A single DCI to schedule both PDSCH(s) and PUSCH(s);
   A single DCI to schedule one or multiple TBs where any single TB can be mapped over multiple slots, where mapping is not by repetition; and
   A single DCI to schedule N TBs (N>1) where a TB can be repeated over multiple slots (or mini-slots)
Note: This does not imply that existing slot aggregation and/or repetition for a PDSCH and PUSCH by a single DCI is precluded for the serving cell.
For a DCI scheduling multiple PDSCHs, HARQ-ACK information corresponding to the PDSCHs scheduled by the DCI is multiplexed with a single PUCCH in a slot that is determined based on K1,
   where K1 (indicated by the PDSCH-to-HARQ_feedback timing indicator field in the DCI or provided by a higher layer parameter such as dl-DataToUL-ACK if the PDSCH-to-HARQ_feedback timing indicator field is not present in the DCI) indicates the slot offset between the slot of the last PDSCH scheduled by the DCI and the slot carrying the HARQ-ACK information corresponding to the scheduled PDSCHs.
      It is noted that the granularity of K1 can be separately discussed.

In some embodiments of the present disclosure, in the case of a relatively high SCS, when multiple PDSCHs are scheduled by a DCI format, the HARQ-ACK feedback corresponding to the multiple PDSCHs may be transmitted in the same PUCCH. This PUCCH may be indicated by a single PDSCH-to-HARQ-ACK feedback timing indicator and a single PUCCH resource indicator in the DCI format.

Considering the short duration of a slot in the case of relatively high SCS, the UE processing time may require a few slots for decoding a PDSCH and generating the corresponding HARQ-ACK feedback.

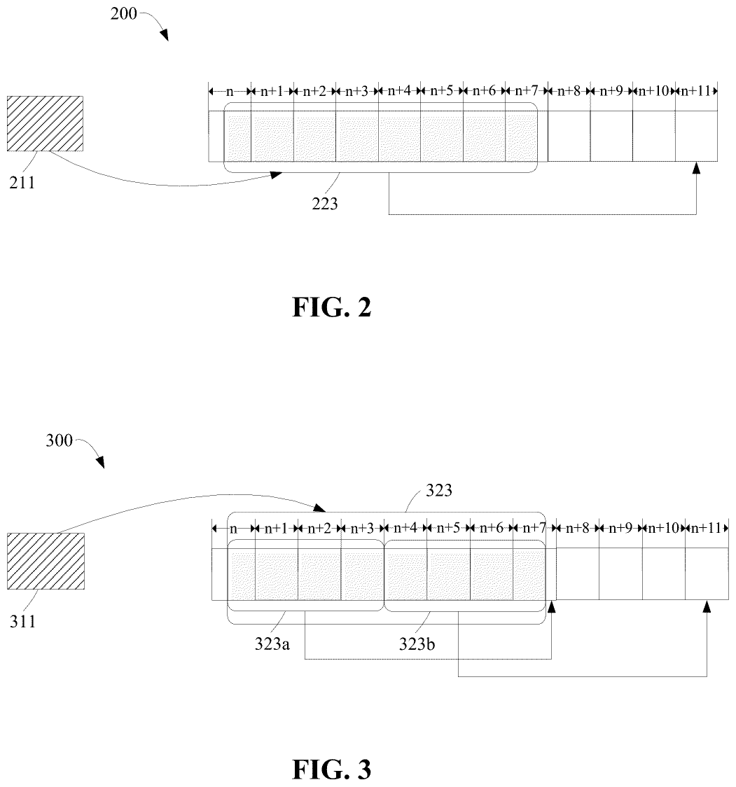

For example, FIG. 2 illustrates a schematic diagram 200 of a HARQ-ACK feedback transmission for PDSCHs scheduled by a DCI format in accordance with some embodiments of the present disclosure. As shown in FIG. 2, DCI format 211 may schedule a plurality of PDSCHs 223 (e.g., 8 PDSCHs) on a plurality of slots (e.g., slot n to slot n+7). Considering the short duration, assuming that 4 slots are required for a UE to transmit the HARQ-ACK feedback in one slot after decoding the last PDSCH of the plurality of scheduled PDSCHs, the HARQ-ACK feedback for the plurality of PDSCHs 223 may be indicated to be transmitted in, for example, slot n+11 on the same PUCCH.

It should be understood that FIG. 2 is only for illustrative purposes, and should not be construed as limiting the embodiments of the present disclosure. For example, although in FIG. 2, the first slot and the last slot (e.g., slot n and slot n+7) of the plurality of slots are not fully scheduled, it is contemplated that in some embodiments of the present disclosure, the first slot, the last slot, or both may be fully scheduled. For example, the first scheduled symbol in the first scheduled slot (e.g., slot n) may be the first symbol (e.g., symbol 0) in this slot. In addition, although in FIG. 2, the scheduled PDSCHs 223 are consecutive in the time domain, it is contemplated that in some embodiments of the present disclosure, the scheduled PDSCHs 223 may be non-consecutive in the time domain.

However, there may be some drawbacks in the above embodiments. For example, latency may be relatively large for the PDSCHs scheduled relatively earlier in the time domain, for example, the PDSCHs scheduled in slot n, slot n+1, slot n+2, or slot n+3 in FIG. 2. The HARQ process number may be starved due to that a maximum of 16 HARQ processes can be configured per UE per serving cell.

Embodiments of the present disclosure provide solutions to solve the above issues. For example, solutions for transmitting HARQ-ACK feedback for a PDSCH(s) scheduled by a DCI format are proposed. In some embodiments of the present disclosure, HARQ-ACK feedback for different PDSCHs scheduled by multi-PDSCH scheduling may be carried by different PUCCHs. More details on the embodiments of the present disclosure will be illustrated in the following text in combination with the appended drawings.

It should be understood that although some of the below solutions are described to support one or two PUCCH transmissions for multi-PDSCH scheduling, it should be appreciated by persons skilled in the art that these solutions can be applied to more than two PUCCH transmissions for multi-PDSCH scheduling.

In the case of single-PDSCH scheduling, that is, a DCI format scheduling a single PDSCH, the DCI format may include an indicator (e.g., PDSCH-to-HARQ_feedback timing indicator) for determining the timing of the HARQ-ACK feedback for the PDSCH scheduled by the DCI format. For example, the PDSCH-to-HARQ_feedback timing indicator may indicate a slot level offset between the slot where the scheduled PDSCH is transmitted and the slot where the corresponding HARQ-ACK feedback or PUCCH is transmitted. The DCI format may further include an indicator (e.g., PUCCH resource indicator) for determining a PUCCH resource for the PUCCH carrying the HARQ-ACK feedback.

In some embodiments of the present disclosure, to support two PUCCH transmissions for multi-PDSCH scheduling, a DCI format may include two PDSCH-to-HARQ_feedback timing indicators for two PUCCH transmissions, respectively. In some examples, DCI format may further include two PUCCH resource indicators for the two PUCCH transmissions, respectively. One of the drawbacks of these embodiments is that extra bits are required which may result in a high overhead of the DCI signaling. For example, each of a PDSCH-to-HARQ_feedback timing indicator and a PUCCH resource indicator may include 3 bits. 6 extra bits may be required in the DCI format. Considering the single DCI already has a high payload size to support new data indicator (NDI) bit and redundancy version (RV) bits per transport block (TB), 6 extra bits on PUCCH may be somewhat unreasonable.

In some embodiments of the present disclosure, a DCI format may include a single PDSCH-to-HARQ_feedback timing indicator and a single PUCCH resource indicator. That is, the same PUCCH resource indicator and PDSCH-to-HARQ_feedback indicator may be applied to two PUCCH transmissions. The DCI format may further indicate a threshold value, which may be applied to the PUCCH transmissions.

For instance, when the number of PDSCHs scheduled by a single DCI format is not larger than the threshold value, only a single PUCCH is transmitted for carrying HARQ-ACK feedback for all the scheduled PDSCHs. Otherwise, when the number of PDSCHs scheduled by a single DCI format is larger than the threshold value, two PUCCHs may be transmitted. In some examples, the first transmitted PUCCH may carry HARQ-ACK feedback for the first several PDSCHs of the plurality of PDSCHs scheduled by the DCI format and may be transmitted K1 slots after the last one of the first several PDSCHs (K1 is indicated by the PDSCH-to-HARQ_feedback timing indicator). The number of the first several PDSCHs may equal the threshold value. The second transmitted PUCCH may carry HARQ-ACK feedback for the remaining PDSCHs and may be transmitted K1 slots after the last scheduled PDSCH of the plurality of PDSCHs.

One of the drawbacks of these embodiments is that in some cases, the first transmitted PUCCH may be overlapped with the DL transmission (e.g., one of the plurality of PDSCHs scheduled by the DCI format). Thus, the UE cannot transmit the first PUCCH. This issue may not exist when the scheduled PDSCHs are non-consecutive, where the UE can transmit the first PUCCH before the end of the last scheduled PDSCH. However, non-consecutive PDSCHs may lead to high RRC signaling overhead on time domain resource allocation.

In some embodiments of the present disclosure, a DCI format may include a single PDSCH-to-HARQ_feedback timing indicator. However, the indicated K1 may only be applied to the scheduled PDSCHs that can be processed by the UE according to UE's processing capability. That is, the UE may transmit a PUCCH (PUCCH #1) carrying only HARQ-ACK feedback for these PDSCHs. For the scheduled PDSCH(s) that do not fulfil the processing delay, the corresponding HARQ feedback may be suspended and to be scheduled by a subsequent DCI format. One of the drawbacks of these embodiments is that it may increase latency for the PDSCH(s) which cannot be acknowledged in PUCCH #1.

Embodiments of the present disclosure further provide enhanced solutions for PUCCH transmissions in the case of multi-PDSCH scheduling.

In some embodiments of the present disclosure, a HARQ-ACK feedback timing set may be configured for a UE by radio resource control (RRC) signaling. The HARQ-ACK timing set may include a plurality of subsets, each of which may include at least one time offset value for transmitting HARQ-ACK feedback. For example, the HARQ-ACK timing set may be configured as {{2}, {2, 2}, {2, 3}, {3}, {3, 4}, {4}, {4, 4}, {4, 5}}. Each time offset value may correspond to a respective PUCCH transmission occasion.

A DCI format may indicate one subset from the plurality of subsets. For example, the PDSCH-to-HARQ_feedback indicator in the DCI format may indicate one subset (e.g., subset #1) from the plurality of subsets. In some examples, the number of PUCCH transmissions for a plurality of PDSCHs scheduled by the DCI format can be implicitly determined from the number of time offset values in subset #1. For example, the number of the PUCCH transmissions may equal the number of time offset values in subset #1. A UE may determine the number of PUCCHs and the HARQ-ACK feedback timing based on the time offset value(s) in the subset indicated by the single PDSCH-to-HARQ_feedback indicator in the DCI format.

In the case that the PDSCH-to-HARQ_feedback indicator in a DCI format indicates a subset including a single time offset value, the UE may assume that the HARQ-ACK feedback for all the PDSCHs scheduled by the DCI format is to be transmitted in a single PUCCH, and may transmit the PUCCH according to the single time offset value. For example, the PUCCH may be transmitted in slot x+y, wherein slot x is the slot where the last PDSCH of the scheduled PDSCHs is transmitted and the value of y is indicated by the PDSCH-to-HARQ_feedback indicator in the DCI format, i.e., the single time offset value.

In the case that the PDSCH-to-HARQ_feedback indicator in a DCI format indicates a subset including more than one, for example, two time offset values, the UE may assume that the HARQ-ACK feedback for the PDSCHs scheduled by the DCI format is to be transmitted in, for example, two PUCCHs (e.g., PUCCH #A1 and PUCCH #A2).

The UE may divide all the scheduled PDSCHs into two PDSCH sets (e.g., PDSCH set #A1 and PDSCH set #A2), each of which may correspond to a respective one of the two PUCCHs. Various methods can be employed to divide the scheduled PDSCHs into PDSCH sets and will be described in detail in the following text. For the PDSCHs in the same PDSCH set, the corresponding HARQ-ACK feedback is to be transmitted in the same PUCCH. For the PDSCHs in different PDSCH sets, the corresponding HARQ-ACK feedback is to be transmitted in different PUCCHs. For example, HARQ-ACK feedback for PDSCHs in PDSCH set #A1 may be transmitted on PUCCH #A1 and HARQ-ACK feedback for PDSCHs in PDSCH set #A2 may be transmitted on PUCCH #A2.

The UE may transmit one of the two PUCCHs (e.g., PUCCH #A1 or PUCCH #A2) according to one of the two time offset values and the other PUCCH (e.g., PUCCH #A2 or PUCCH #A1) according to the other time offset value. For example, PUCCH #A1 may be transmitted in slot x1+y1, where slot x1 may be the slot where the last PDSCH of PDSCH set #A1 is transmitted and the value of y1 may be the first time offset value (e.g., 3) in the indicated subset (e.g., {3, 4}). PUCCH #A2 may be transmitted in slot x2+y2, where slot x2 may be the slot where the last PDSCH of PDSCH set #A2 is transmitted and the value of y2 may be the other time offset value (e.g., 4) in the indicated subset (e.g., {3, 4}).

In some other examples, slot x1, slot x2 or both may have different meanings. For example, slot x1 may be the slot where the first PDSCH of PDSCH set #A1 is transmitted. Slot x2 may be the slot where the first PDSCH of PDSCH set #A2 is transmitted.

The scheduled PDSCHs may be divided into a plurality of (e.g., two) PDSCH sets according to one of the following methods. Alternatives, modifications, and variations of these methods may be apparent to those skilled in the art.

In some embodiments of the present disclosure, all the scheduled PDSCHs by a DCI format may be approximately equally divided into two PDSCH sets. For example, assuming the number of scheduled PDSCHs is Y, the first

$$⌈ \frac{Y}{2} ⌉ or ( ⌈ \frac{Y}{2} ⌉ - 1 )$$

of the scheduled PDSCHs may be included in PDSCH set #A1 and the remaining scheduled PDSCHs may be included in PDSCH set #A2.

In some embodiments of the present disclosure, the first M PDSCHs of the scheduled PDSCHs may be included in PDSCH set #A1 and the remaining Y-M scheduled PDSCHs may be included in PDSCH set #A2. In some examples, the value of M may be configured by an RRC signaling message. In some examples, the value of M may be predefined, for example, in a standard(s).

For example, a mapping relationship between the number of PDSCHs scheduled by a DCI format and the value of M may be predefined. For instance, Table 2 below shows an exemplary mapping relationship. It should be understood that Table 2 is only for illustrative purposes, and should not be construed as limiting the embodiments of the present disclosure.

TABLE 2
The value of M corresponding to
the number of scheduled PDSCHs

| Number of scheduled | |
|---|---|
| PDSCHs | Value of M |
| 1 | 1 |
| 2 | 2 |
| 3 | 3 |
| 4 | 4 |
| 5 | 4 |
| 6 | 4 |
| 7 | 4 |
| 8 | 4 |
| 9 | 5 |
| 10 | 5 |
| 11 | 6 |
| 12 | 6 |

According to the above Table 2, in the case that 8 PDSCHs are scheduled by a DCI format, a UE may transmit two PUCCHs, one of which may carry HARQ-ACK feedback for the first 4 scheduled PDSCHs and the other may carry HARQ-ACK feedback for the last 4 scheduled PDSCHs.

In some embodiments of the present disclosure, a DCI format may indicate a subset including more than two time offset values, for example, when the maximum number (e.g., 12, 16, 20, 24, or 32) of scheduled PDSCHs by the single DCI format is relatively large.

For example, in case that the PDSCH-to-HARQ_feedback indicator in the DCI format indicates a subset including 3 time offset values, the scheduled PDSCHs may be divided into 3 PDSCH sets (e.g., PDSCH set #B1, PDSCH set #B2, and PDSCH set #B3). The above methods for dividing the scheduled PDSCHs may be similarly applied. For example, PDSCH set #B1 may include the first

$$⌈ \frac{Y}{3} ⌉ or ( ⌈ \frac{Y}{3} ⌉ - 1 )$$

of the scheduled PDSCHs, PDSCH set #B3 may include the last

$$⌈ \frac{Y}{3} ⌉ or ( ⌈ \frac{Y}{3} ⌉ - 1 )$$

of the scheduled PDSCHs, and PDSCH set #B2 may include the remaining PDSCHs.

FIG. 3 illustrates a schematic diagram 300 of HARQ-ACK feedback transmissions for PDSCHs scheduled by a DCI format in accordance with some embodiments of the present disclosure.

As shown in FIG. 3, DCI format 311 may schedule a plurality of PDSCHs 323 (e.g., 8 PDSCHs) on a plurality of slots (e.g., slot n to slot n+7). In some examples, the HARQ-ACK timing set may be configured as {{2}, {2, 2}, {2, 3}, {3}, {3, 4}, {4}, {4, 4}, {4, 5}}.

Assuming that the PDSCH-to-HARQ_feedback indicator in DCI format 311 indicates a subset of {4, 4}, the UE may assume that the HARQ-ACK feedback corresponding to the 8 scheduled PDSCHs is to be transmitted in two PUCCHs (e.g., PUCCH #C1 and PUCCH #C2). The UE may divide the 8 scheduled PDSCHs into two PDSCH sets (e.g., PDSCH set #C1 and PDSCH set #C2) according to one of the methods as described above. For example, the UE may receive an RRC signaling message configuring the value of M as 4. PDSCH set #C1 may include the first 4 scheduled PDSCHs 323a and PDSCH set #C2 may include the remaining 4 scheduled PDSCHs 323b. PUCCH #C1 may be used to carry HARQ-ACK feedback for PDSCHs in PDSCH set #C1 and PUCCH #C2 may be used to carry HARQ-ACK feedback for PDSCHs in PDSCH set #C2. PUCCH #C1 and PUCCH #C2 may be transmitted according to the indicated subset. For example, PUCCH #C1 may be transmitted in slot n+7 (i.e., slot n+3+4) since the last PDSCH of PDSCH set #C1 is transmitted in slot n+3 and the first time offset value in the subset is 4. PUCCH #C2 may be transmitted in slot n+11 (i.e., n+7+4) since the last PDSCH of PDSCH set #C2 is transmitted in slot n+7 and the second time offset value in the subset is 4.

In some embodiments of the present disclosure, an indicator (hereinafter, “PUCCH number indicator”) for indicating the number of PUCCH transmissions may be included in the DCI format scheduling the plurality of PDSCHs.

The number of bits of the PUCCH number indicator may be dependent on the maximum number of PUCCHs supported. For example, when at most two PUCCHs are supported, one bit in the DCI format is sufficient for the PUCCH number indicator. For instance, bit “0” may indicate a single PUCCH for all the scheduled PDSCHs and bit “1” may indicate two PUCCHs for all the scheduled PDSCHs; or vice versa. The DCI format (e.g., the PDSCH-to-HARQ_feedback indicator) may further indicate a single time offset value for transmitting HARQ-ACK feedback.

In the case that the PUCCH number indicator indicates a single PUCCH transmission, the HARQ-ACK feedback for all the PDSCHs scheduled by the DCI format is transmitted in slot x3+y3, wherein slot x3 may be the slot where the last scheduled PDSCH is transmitted and the value of y3 is indicated by the PDSCH-to-HARQ_feedback indicator in the DCI format, i.e., the single time offset value.

In the case that the PUCCH number indicator indicates two PUCCH transmissions (e.g., PUCCH #D1 and PUCCH #D2), the PDSCHs scheduled by a DCI format may be divided into two PDSCH sets (e.g., PDSCH set #D1 and PDSCH set #D2). The methods for dividing the scheduled PDSCHs described above may apply here and thus are omitted herein. For example, referring to FIG. 3, PDSCH set #D1 may include the first 4 scheduled PDSCHs 323a and PDSCH set #D2 may include the remaining 4 scheduled PDSCHs 323b. PUCCH #D1 may be used to carry HARQ-ACK feedback for PDSCHs in PDSCH set #D1 and PUCCH #D2 may be used to carry HARQ-ACK feedback for PDSCHs in PDSCH set #D2.

Various methods may be employed to determining the timing for transmitting the two PUCCHs. Alternatives, modifications, and variations of these methods may be apparent to those skilled in the art.

In some embodiments of the present disclosure, PUCCH #D1 may be transmitted in a predefined slot and PUCCH #D2 may be transmitted according to the single time offset value indicated by the DCI format. For example, PUCCH #D2 may be transmitted in slot x4+y4, wherein slot x4 may be the slot where the last scheduled PDSCH of all the PDSCHs scheduled by the DCI format is transmitted and y4 is the single time offset value. In other words, the single time offset value may be with reference to the slot where the last scheduled PDSCH of all the scheduled PDSCHs is transmitted.

In some embodiments, the predefined slot may be the slot where the last scheduled PDSCH of all the PDSCHs scheduled by the DCI format is transmitted. In some other embodiments, the predefined slot may be the slot immediately following the slot where the last scheduled PDSCH of all the PDSCHs scheduled by the DCI format is transmitted. In yet other embodiments, the predefined slot may be determined based on a slot level offset, which may be configured by an RRC signaling message.

In some examples, the slot level offset may be with reference to the slot where the first scheduled PDSCH of all the PDSCHs scheduled by the DCI format is transmitted. In some other examples, the slot level offset may be with reference to the slot where the last scheduled PDSCH of PDSCH set #D1 is transmitted. For example, assuming that the slot level offset is with reference to the slot where the first scheduled PDSCH of PDSCHs 323 (e.g., the PDSCH transmitted in slot n shown in FIG. 3) and is configured as 7, the UE may transmit PUCCH #D1 carrying HARQ-ACK feedback for PDSCHs 323a in slot n+7.

In some embodiments of the present disclosure, PUCCH #D1 may be transmitted according to the single time offset value indicated by the DCI format.

In some examples, PUCCH #D1 may be transmitted in slot x5+y5, wherein slot x5 may be the slot where the last scheduled PDSCH of PDSCH set #D1 is transmitted and y5 is the single time offset value. In other words, the single time offset value may be with reference to the slot where the last scheduled PDSCH of PDSCH set #D1 is transmitted.

In some other examples, PUCCH #D1 may be transmitted in slot x6+y6, wherein slot x6 may be the slot where the first scheduled PDSCH of all the PDSCHs scheduled by the DCI format is transmitted and y6 is the single time offset value. In other words, the single time offset value may be with reference to the slot where the first scheduled PDSCH of all the PDSCHs scheduled by the DCI format is transmitted.

PUCCH #D2 may be in a predefined slot. In some embodiments, the predefined slot may be the slot where the last scheduled PDSCH of all the PDSCHs scheduled by the DCI format is transmitted. In some other embodiments, the predefined slot may be the slot immediately following the slot where the last scheduled PDSCH of all the PDSCHs scheduled by the DCI format is transmitted. In yet other embodiments, the predefined slot may be determined based on a slot level offset, which may be configured by an RRC signaling message.

In some examples, the slot level offset may be with reference to the slot where the first scheduled PDSCH of all the PDSCHs scheduled by the DCI format is transmitted. In some other examples, the slot level offset may be with reference to the slot where the last scheduled PDSCH of all the PDSCHs scheduled by the DCI format is transmitted. For example, assuming that the slot level offset is with reference to the slot where the last scheduled PDSCH of all the PDSCHs (e.g., the PDSCH transmitted in slot n+7 shown in FIG. 3) and is configured as 4, the UE may transmit PUCCH #D2 carrying HARQ-ACK feedback for PDSCHs 323b in slot n+11.

For instance, referring to FIG. 3, in some examples, a UE may be configured with a HARQ-ACK feedback timing set of {1, 2, 3, 4, 5, 6, 7, 8}. Assuming that DCI format 311 includes a PUCCH number indicator indicating two PUCCH transmissions, the UE may assume that the HARQ-ACK feedback for all the 8 PDSCHs scheduled by DCI format 311 is to be transmitted in two PUCCHs (e.g., PUCCH #E1 and PUCCH #E2). The UE may use one of the above-described methods for dividing PDSCHs 323 into two PDSCH sets (e.g., PDSCH set #E1 and PDSCH set #E2). For example, the UE may receive an RRC signaling message configuring the value of M as 4. PDSCH set #E1 may include the first 4 scheduled PDSCHs 323a and PDSCH set #E2 may include the remaining 4 scheduled PDSCHs 323b. PUCCH #E1 may be used to carry HARQ-ACK feedback for PDSCHs in PDSCH set #E1 and PUCCH #E2 may be used to carry HARQ-ACK feedback for PDSCHs in PDSCH set #E2.

The UE may use one of the above-described methods for determining the timing for transmitting the two PUCCHs. For example, PUCCH #E1 may be transmitted in a predefined slot, and PUCCH #E2 may be transmitted according to the PDSCH-to-HARQ_feedback indicator. For instance, assuming that the PDSCH-to-HARQ_feedback indicator indicating the value of “4” from the HARQ-ACK feedback timing set and is with reference to the last scheduled PDSCH, PUCCH #E2 may be transmitted in slot n+11 (i.e., n+7+4). Assuming that the predefined slot is defined as the slot where the last scheduled PDSCH of all the PDSCHs scheduled by the DCI format is transmitted, PUCCH #E1 may be transmitted in slot n+7.

In some embodiments of the present disclosure, the number of PUCCH transmissions for the plurality of PDSCHs scheduled by a DCI format may be determined based on the number of the plurality of PDSCHs. For example, the number of PUCCH transmissions may be determined based on the number of the plurality of PDSCHs (denoted as “Y”) and a threshold (e.g., previously described parameter M).

For instance, when Y is less than or equal to the threshold, a single PUCCH may be transmitted for the Y scheduled PDSCHs; otherwise, when Y is greater than the threshold, two PUCCHs may be transmitted for the Y scheduled PDSCHs. The description of the value M as described above may be applied to the threshold. For example, the value of the threshold may be configured by an RRC signaling message, or may be predefined in the form of, for example, a mapping relationship between the number of PDSCHs scheduled by a DCI format and the value of the threshold.

The DCI format (e.g., the PDSCH-to-HARQ_feedback indicator) may indicate a single time offset value for transmitting HARQ-ACK feedback. In the case that a single PUCCH is transmitted, the HARQ-ACK feedback for the Y scheduled PDSCHs may be transmitted in one PUCCH according to the single time offset value. For example, the HARQ-ACK feedback for all the PDSCHs scheduled by the DCI format may be transmitted in slot x7+y7, wherein slot x7 may be the slot where the last scheduled PDSCH is transmitted and the value of y7 is indicated by the PDSCH-to-HARQ_feedback indicator in the DCI format.

In the case that two PUCCHs (e.g., PUCCH #F1 and PUCCH #F2) are transmitted, the PDSCHs scheduled by a DCI format may be divided into two PDSCH sets (e.g., PDSCH set #F1 and PDSCH set #F2), according to one of the methods for dividing the scheduled PDSCHs as described above. For example, PDSCH set #F1 may include the first M PDSCHs of the Y scheduled PDSCHs, and PDSCH set #F2 may include the remaining Y−M PDSCHs of the Y scheduled PDSCHs. PUCCH #F1 may be used to carry HARQ-ACK feedback for PDSCHs in PDSCH set #F1 and PUCCH #F2 may be used to carry HARQ-ACK feedback for PDSCHs in PDSCH set #F2.

The methods for determining the timing for transmitting the two PUCCHs described above may apply here. For example, as described above, in some cases, PUCCH #F1 may be transmitted in a predefined slot and PUCCH #F2 may be transmitted according to the single time offset value indicated by the DCI format. In some other cases, PUCCH #F1 may be transmitted according to the single time offset value indicated by the DCI format and PUCCH #F2 may be in a predefined slot.

For instance, referring to FIG. 3, in some examples, assuming that the above Table 2 is defined in a 3GPP standard, a UE receiving DCI format 311 which schedules 8 PDSCHs may determine that the HARQ-ACK feedback for the 8 scheduled PDSCHs is to be transmitted in two PUCCHs (e.g., PUCCH #G1 and PUCCH #G2). The UE may use one of the above-described methods for dividing the 8 scheduled PDSCHs into two PDSCH sets (e.g., PDSCH set #G1 and PDSCH set #G2). For example, PDSCH set #G1 may include the first 4 scheduled PDSCHs 323a and PDSCH set #G2 may include the remaining 4 scheduled PDSCHs 323b. PUCCH #G1 may be used to carry HARQ-ACK feedback for PDSCHs in PDSCH set #G1 and PUCCH #G2 may be used to carry HARQ-ACK feedback for PDSCHs in PDSCH set #G2.

The UE may use one of the above-described methods for determining the timing for transmitting the two PUCCHs. For example, PUCCH #G1 may be transmitted in a predefined slot, and PUCCH #G2 may be transmitted according to the PDSCH-to-HARQ_feedback indicator. For instance, assuming that the PDSCH-to-HARQ_feedback indicator indicating the value of “4” from the HARQ-ACK feedback timing set and is with reference to the last scheduled PDSCH, PUCCH #G2 may be transmitted in slot n+11 (i.e., n+7+4). Assuming that the predefined slot is defined as the slot where the last scheduled PDSCH of all the PDSCHs scheduled by the DCI format is transmitted, PUCCH #G1 may be transmitted in slot n+7.

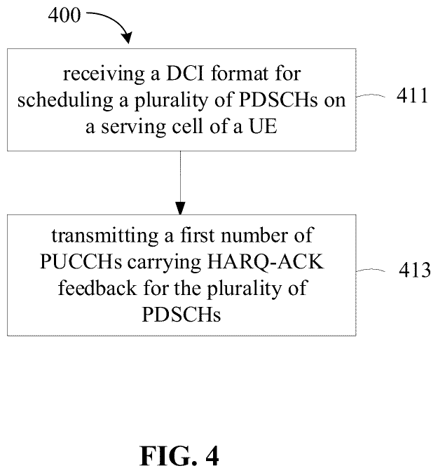

FIG. 4 illustrates a flow chart of an exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a UE, for example, UE 101 in FIG. 1.

Referring to FIG. 4, in operation 411, a UE may receive a DCI format for scheduling a plurality of PDSCHs on a serving cell of the UE. In operation 413, the UE may transmit a first number of PUCCHs carrying HARQ-ACK feedback for the plurality of PDSCHs.

In some embodiments of the present disclosure, the plurality of PDSCHs may be divided into the first number of PDSCH sets. The HARQ-ACK feedback for each of the first number of PDSCH sets may be carried by a corresponding PUCCH of the first number of PUCCHs. The UE may employ one of the methods as described above for dividing the plurality of PDSCHs.

In some examples, the plurality of PDSCHs may be approximately equally divided into the first number of PDSCH sets. In some other examples, the first M PDSCHs of the plurality of PDSCHs are included in a PDSCH set, and the remaining PDSCHs of the plurality of PDSCHs are included in another PDSCH set. The value of M may be predefined by a mapping relationship between the number of PDSCHs scheduled by a DCI format and the value of M, or is configured by an RRC signaling message.

In some embodiments of the present disclosure, the UE may further receive an RRC signaling message configuring a HARQ-ACK feedback timing set. The HARQ-ACK timing set may include a plurality of subsets and each of the plurality of subsets may include at least one time offset value for transmitting HARQ-ACK feedback. For example, the HARQ-ACK timing set may be configured as {{2}, {2, 2}, {2, 3}, {3}, {3, 4}, {4}, {4, 4}, {4, 5}}. The DCI format may indicate one subset (hereinafter, “first subset”) from the plurality of subsets. The value of the first number may equal the number of time offset values in the first subset.

In some examples, the first subset may include two time offset values. The value of the first number is two. The UE may transmit the first number of PUCCHs by transmitting a PUCCH carrying HARQ-ACK feedback for a PDSCH set of the first number of PDSCH sets according to one of the two time offset values, and transmitting another PUCCH carrying HARQ-ACK feedback for the other PDSCH set of the first number of PDSCH sets according to the other one of the two time offset values.

In some examples, the first subset may include a single time offset value. The value of the first number is one. The UE may transmit the first number of PUCCHs by transmitting a single PUCCH carrying HARQ-ACK feedback for the plurality of PDSCHs according to the single time offset value.

In some embodiments of the present disclosure, the DCI format may indicate a value of the first number. For example, the DCI format may include a PUCCH number indicator as described above to indicate the number of PUCCH transmissions.

In some other embodiments of the present disclosure, the value of the first number may be determined based on the number of the plurality of PDSCHs scheduled by the DCI format and a threshold. The threshold may be the previously described parameter M. For example, the value of the threshold may be configured by an RRC signaling message, or may be predefined by, for example, a mapping relationship between the number of PDSCHs scheduled by a DCI format and the value of the threshold.

The UE may employ one of the methods as described above for determining the timing for transmitting the first number of PUCCHs.

In some embodiments of the present disclosure, the DCI format may indicate a single time offset value for transmitting HARQ-ACK feedback. For example, the DCI format may include a PDSCH-to-HARQ_feedback indicator to indicate the single time offset value.

In the case that the value of the first number is one, the UE may transmit the first number of PUCCHs by transmitting a PUCCH carrying HARQ-ACK feedback for the plurality of PDSCHs scheduled by the DCI format according to the single time offset value.

In the case that the value of the first number is two, in some examples, the UE may transmit the first number of PUCCHs by transmitting a PUCCH (hereinafter, “PUCCH #H1”) carrying HARQ-ACK feedback for a PDSCH set (hereinafter, “PDSCH set #H1”) of the first number of PDSCH sets on a predefined slot, and transmitting another PUCCH (hereinafter, “PUCCH #H2”) carrying HARQ-ACK feedback for the other PDSCH set (hereinafter, “PDSCH set #H2”) of the first number of PDSCH sets according to the single time offset value. In some other examples, the UE may transmit the first number of PUCCHs by transmitting PUCCH #H1 according to the single time offset value and transmitting PUCCH #H2 on the predefined slot.

In some embodiments of the present disclosure, the predefined slot may be one of the following: the slot where the last PDSCH of the plurality of PDSCHs is transmitted; the slot immediately following the slot where the last PDSCH of the plurality of PDSCHs is transmitted; and determined based on a slot level offset configured by an RRC signaling message.

In some embodiments of the present disclosure, the slot level offset may be with reference to one of the following: the slot where the first scheduled PDSCH of the plurality of PDSCHs is transmitted; the slot where the last scheduled PDSCH of PDSCH set #H1 is transmitted; and the slot where the last scheduled PDSCH of the plurality of PDSCHs is transmitted.

In some embodiments of the present disclosure, the single time offset may be with reference to one of the following: the slot where the last scheduled PDSCH of the plurality of PDSCHs is transmitted; the slot where the last scheduled PDSCH of PDSCH set #H1 is transmitted; and the slot where the first scheduled PDSCH of the plurality of PDSCHs is transmitted.

It should be appreciated by persons skilled in the art that the sequence of the operations in exemplary procedure 400 may be changed and some of the operations in exemplary procedure 400 may be eliminated or modified, without departing from the spirit and scope of the disclosure.

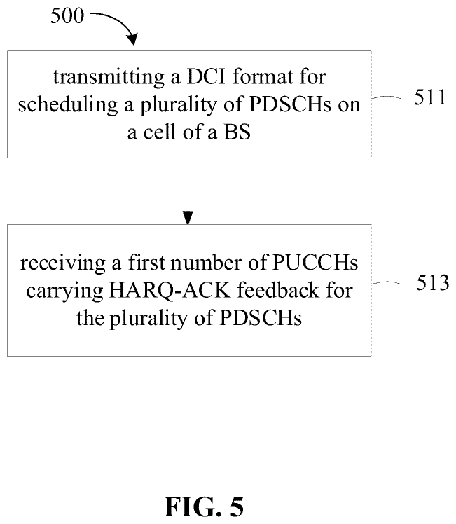

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a BS, for example, BS 102 in FIG. 1.

Referring to FIG. 5, in operation 511, a BS may transmit a DCI format for scheduling a plurality of PDSCHs on a cell of the BS. In operation 513, the BS may receive a first number of PUCCHs carrying HARQ-ACK feedback for the plurality of PDSCHs.

In some embodiments of the present disclosure, the plurality of PDSCHs may be divided into the first number of PDSCH sets. The HARQ-ACK feedback for each of the first number of PDSCH sets may be carried by a corresponding PUCCH of the first number of PUCCHs. Various methods as described above may be employed for dividing the plurality of PDSCHs.

In some examples, the plurality of PDSCHs may be approximately equally divided into the first number of PDSCH sets. In some other examples, the first M PDSCHs of the plurality of PDSCHs are included in a PDSCH set, and the remaining PDSCHs of the plurality of PDSCHs are included in another PDSCH set. In some cases, the value of M may be predefined by a mapping relationship between the number of PDSCHs scheduled by a DCI format and the value of M. In some other cases, the BS may transmit an RRC signaling message configuring the value of M.

In some embodiments of the present disclosure, the BS may further transmit an RRC signaling message for configuring a HARQ-ACK feedback timing set. The HARQ-ACK timing set may include a plurality of subsets and each of the plurality of subsets may include at least one time offset value for transmitting HARQ-ACK feedback. For example, the HARQ-ACK timing set may be configured as {{2}, {2, 2}, {2, 3}, {3}, {3, 4}, {4}, {4, 4}, {4, 5}}. The DCI format may indicate one subset (hereinafter, “first subset”) from the plurality of subsets. The value of the first number may equal the number of time offset values in the first subset.

In some examples, the first subset may include two time offset values. The value of the first number is two. The BS may receive the first number of PUCCHs by receiving a PUCCH carrying HARQ-ACK feedback for a PDSCH set of the first number of PDSCH sets according to one of the two time offset values, and receiving another PUCCH carrying HARQ-ACK feedback for the other PDSCH set of the first number of PDSCH sets according to the other one of the two time offset values.

In some examples, the first subset may include a single time offset value. The value of the first number is one. The BS may receive the first number of PUCCHs by receiving a single PUCCH carrying HARQ-ACK feedback for the plurality of PDSCHs according to the single time offset value.

In some embodiments of the present disclosure, the DCI format may indicate a value of the first number. For example, the DCI format may include a PUCCH number indicator as described above to indicate the number of PUCCH transmissions.

In some other embodiments of the present disclosure, the value of the first number may be determined based on the number of the plurality of PDSCHs scheduled by the DCI format and a threshold. The threshold may be the previously described parameter M. For example, the value of the threshold may be predefined by, for example, a mapping relationship between the number of PDSCHs scheduled by a DCI format and the value of the threshold. Or the BS may transmit an RRC signaling message to configure the threshold.

Various methods as described above may be employed to determine the timing for transmitting the first number of PUCCHs.

In some embodiments of the present disclosure, the DCI format may indicate a single time offset value for transmitting HARQ-ACK feedback. For example, the DCI format may include a PDSCH-to-HARQ_feedback indicator to indicate the single time offset value.

In the case that the value of the first number is one, the BS may receive the first number of PUCCHs by receiving a PUCCH carrying HARQ-ACK feedback for the plurality of PDSCHs scheduled by the DCI format according to the single time offset value.

In the case that the value of the first number is two, in some examples, the BS may receive the first number of PUCCHs by receiving a PUCCH (hereinafter, “PUCCH #I1”) carrying HARQ-ACK feedback for a PDSCH set (hereinafter, “PDSCH set #I1”) of the first number of PDSCH sets on a predefined slot, and transmitting another PUCCH (hereinafter, “PUCCH #I2”) carrying HARQ-ACK feedback for the other PDSCH set (hereinafter, “PDSCH set #I2”) of the first number of PDSCH sets according to the single time offset value. In some other examples, the BS may receive the first number of PUCCHs by receiving PUCCH #I1 according to the single time offset value and transmitting PUCCH #I2 on the predefined slot.

In some embodiments of the present disclosure, the predefined slot may be: the slot where the last PDSCH of the plurality of PDSCHs is transmitted; the slot immediately following the slot where the last PDSCH of the plurality of PDSCHs is transmitted; or based on a slot level offset configured by an RRC signaling message.

In some embodiments of the present disclosure, the slot level offset may be with reference to one of the following: the slot where the first transmitted PDSCH of the plurality of PDSCHs is transmitted; the slot where the last transmitted PDSCH of PDSCH set #I1 is transmitted; and the slot where the last transmitted PDSCH of the plurality of PDSCHs is transmitted.

In some embodiments of the present disclosure, the single time offset may be with reference to one of the following: the slot where the last transmitted PDSCH of the plurality of PDSCHs is transmitted; the slot where the last transmitted PDSCH of PDSCH set #I1 is transmitted; and the slot where the first transmitted PDSCH of the plurality of PDSCHs is transmitted.

It should be appreciated by persons skilled in the art that the sequence of the operations in exemplary procedure 500 may be changed and some of the operations in exemplary procedure 500 may be eliminated or modified, without departing from the spirit and scope of the disclosure.

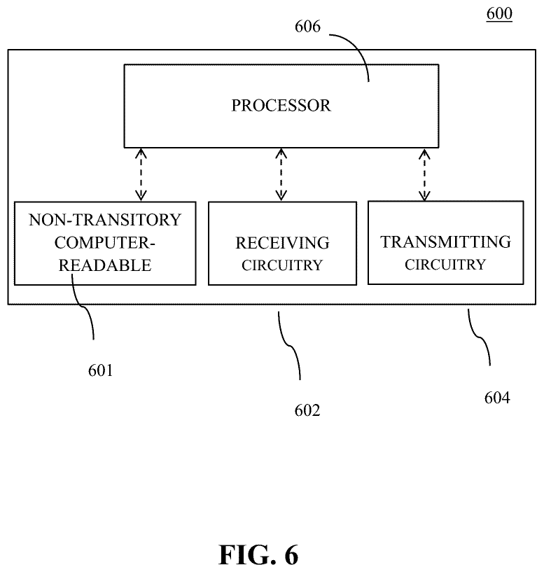

FIG. 6 illustrates a block diagram of an exemplary apparatus 600 according to some embodiments of the present disclosure.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The apparatus 600 may be a base station side apparatus (e.g., a BS) or a communication device (e.g., a UE).

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 are combined into a single device, such as a transceiver. In certain embodiments of the present application, the apparatus 600 may further include an input device, a memory, and/or other components.

In some embodiments of the present disclosure, the non-transitory computer-readable medium 601 may have stored thereon computer-executable instructions to cause a processor to implement the method with respect to the UEs as described above. For example, the computer-executable instructions, when executed, cause the processor 606 interacting with receiving circuitry 602 and transmitting circuitry 604, so as to perform the operations with respect to the UEs described in FIGS. 1-5.

In some embodiments of the present disclosure, the non-transitory computer-readable medium 601 may have stored thereon computer-executable instructions to cause a processor to implement the method with respect to the BSs as described above. For example, the computer-executable instructions, when executed, cause the processor 606 interacting with receiving circuitry 602 and transmitting circuitry 604, so as to perform the operations with respect to the BSs described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
a processor; and
memory coupled with the processor, the processor configured to cause the UE to:
receive a downlink control information (DCI) format for scheduling a plurality of physical downlink shared channels (PDSCHs) on a serving cell of the UE; and
transmit a first number of physical uplink control channels (PUCCHs) carrying hybrid automatic repeat request acknowledgement (HARQ-ACK) feedback for the plurality of PDSCHs,
wherein the plurality of PDSCHs is divided into the first number of PDSCH sets, and HARQ-ACK feedback for each of the first number of PDSCH sets is carried by a corresponding PUCCH of the first number of PUCCHs.

2. The UE of claim 1, wherein the processor is further configured to cause the UE to:
receive a radio resource control (RRC) signaling message configuring a HARQ-ACK feedback timing set, wherein the HARQ-ACK timing set includes a plurality of subsets and each of the plurality of subsets comprises at least one time offset value for transmitting HARQ-ACK feedback;
wherein the DCI format indicates a first subset from the plurality of subsets, and a value of the first number equals a number of time offset values in the first subset.

3. The UE of claim 2, wherein the first subset includes two time offset values, and transmitting the first number of PUCCHs comprises:
transmitting a first PUCCH carrying HARQ-ACK feedback for a first PDSCH set of the first number of PDSCH sets according to one of the two time offset values; and
transmitting a second PUCCH carrying HARQ-ACK feedback for a second PDSCH set of the first number of PDSCH sets according to the other one of the two time offset values.

4. The UE of claim 2, wherein the first subset includes a single time offset value, and transmitting the first number of PUCCHs comprises:
transmitting a single PUCCH carrying HARQ-ACK feedback for the plurality of PDSCHs according to the single time offset value.

5. The UE of claim 1, wherein the DCI format indicates a value of the first number.

6. The UE of claim 1, wherein the processor is further configured to cause the UE to:
determine a value of the first number based on the number of the plurality of PDSCHs and a threshold.

7. The of claim 6, wherein the threshold is predefined by a mapping relationship between the number of PDSCHs scheduled by a DCI format and the value of the threshold, or is configured by a radio resource control (RRC) signaling message.

8. The UE of claim 5, wherein:
the DCI format indicates a single time offset value for transmitting HARQ-ACK feedback; and
when the value of the first number is two, transmitting the first number of PUCCHs comprises:
transmitting a first PUCCH carrying HARQ-ACK feedback for a first PDSCH set of the first number of PDSCH sets on a predefined slot, and transmitting a second PUCCH carrying HARQ-ACK feedback for a second PDSCH set of the first number of PDSCH sets according to the single time offset value; or
transmitting the first PUCCH according to the single time offset value and transmitting the second PUCCH on the predefined slot.

9. The of claim 8, wherein the predefined slot is:
the slot where the last PDSCH of the plurality of PDSCHs is transmitted;
the slot immediately following the slot where the last PDSCH of the plurality of PDSCHs is transmitted; or
determined based on a slot level offset configured by a radio resource control (RRC) signaling message.

10. The UE of claim 9, wherein the slot level offset is with reference to:
the slot where the first scheduled PDSCH of the plurality of PDSCHs is transmitted;
the slot where the last scheduled PDSCH of the first PDSCH set is transmitted; or
the slot where the last scheduled PDSCH of the plurality of PDSCHs is transmitted.

11. The of claim 8, wherein the single time offset is with reference to:
the slot where the last scheduled PDSCH of the plurality of PDSCHs is transmitted;
the slot where the last scheduled PDSCH of the first PDSCH set is transmitted; or
the slot where the first scheduled PDSCH of the plurality of PDSCHs is transmitted.

12. The of claim 1, wherein:
the plurality of PDSCHs is approximately equally divided into the first number of PDSCH sets; or
the first M PDSCHs of the plurality of PDSCHs are included in a first PDSCH set of the first number of PDSCH sets, and the remaining PDSCHs of the plurality of PDSCHs are included in a second PDSCH set of the first number of PDSCH sets,
wherein a value of M is predefined by a mapping relationship between the number of PDSCHs scheduled by a DCI format and the value of M, or the value of M is configured by a radio resource control (RRC) signaling message.

13. A base station (BS), comprising:
a processor; and
memory coupled with the processor, the processor configured to cause the BS to:
transmit a downlink control information (DCI) format for scheduling a plurality of physical downlink shared channels (PDSCHs) on a cell of the BS; and
receive a first number of physical uplink control channels (PUCCHs) carrying hybrid automatic repeat request acknowledgement (HARQ-ACK) feedback for the plurality of PDSCHs,
wherein the plurality of PDSCHs is divided into the first number of PDSCH sets, and HARQ-ACK feedback for each of the first number of PDSCH sets is carried by a corresponding PUCCH of the first number of PUCCHs.

14. The BS of claim 13, wherein the processor is further configured to cause the BS to:
transmit a radio resource control (RRC) signaling message for configuring a HARQ-ACK feedback timing set, wherein the HARQ-ACK timing set includes a plurality of subsets and each of the plurality of subsets comprises at least one time offset value for transmitting HARQ-ACK feedback;
wherein the DCI format indicates a first subset from the plurality of subsets, and a value of the first number equals a number of time offset values in the first subset.

15. (canceled)

16. A processor for wireless communication, comprising:
at least one controller coupled with at least one memory and configured to cause the processor to:
receive a downlink control information (DCI) format for scheduling a plurality of physical downlink shared channels (PDSCHs) on a serving cell of the processor; and
transmit a first number of physical uplink control channels (PUCCHs) carrying hybrid automatic repeat request acknowledgement (HARQ-ACK) feedback for the plurality of PDSCHs,
wherein the plurality of PDSCHs is divided into the first number of PDSCH sets, and HARQ-ACK feedback for each of the first number of PDSCH sets is carried by a corresponding PUCCH of the first number of PUCCHs.

17. The processor of claim 16, wherein the controller is further configured to cause the processor to:
receive a radio resource control (RRC) signaling message configuring a HARQ-ACK feedback timing set, wherein the HARQ-ACK timing set includes a plurality of subsets and each of the plurality of subsets comprises at least one time offset value for transmitting HARQ-ACK feedback;
wherein the DCI format indicates a first subset from the plurality of subsets, and a value of the first number equals a number of time offset values in the first subset.

18. The processor of claim 16, wherein the DCI format indicates a value of the first number.

19. A method performed by a user equipment (UE), the method comprising:
receiving a downlink control information (DCI) format for scheduling a plurality of physical downlink shared channels (PDSCHs) on a serving cell of the UE and
transmitting a first number of physical uplink control channels (PUCCHs) carrying hybrid automatic repeat request acknowledgement (HARQ-ACK) feedback for the plurality of PDSCHs,
wherein the plurality of PDSCHs is divided into the first number of PDSCH sets, and HARQ-ACK feedback for each of the first number of PDSCH sets is carried by a corresponding PUCCH of the first number of PUCCHs.

20. The method of claim 19, wherein the DCI format indicates a value of the first number.

21. The method of claim 19, further comprising determining a value of the first number based on the number of the plurality of PDSCHs and a threshold.
